(19) United States
(12) Patent Application Publication
(10) Pub. No.: US 2024/0416541 A1
(43) Pub. Date: Dec. 19, 2024

(54) COUPLING-TYPE RAZOR HEAD, RAZOR HEAD, AND RAZOR

(71) Applicant: KAI R&D CENTER CO., LTD., Seki-shi (JP)

(72) Inventor: Keita NAKADA, Seki-shi (JP)

(21) Appl. No.: 18/821,596

(22) Filed: Aug. 30, 2024

Related U.S. Application Data
(63) Continuation of application No. PCT/JP2023/005931, filed on Feb. 20, 2023.

(30) Foreign Application Priority Data
Mar. 31, 2022 (JP) 2022-059122

(51) Int. Cl. B26B 21/22

(52) U.S. Cl. CPC B26B 21/227

(57) ABSTRACT

A connection type razor head according to the present disclosure is formed by connecting a plurality of cartridges to one another. In some embodiments, one or more of the plurality of cartridges includes a blade body and a skin contact member positioned in front of the blade body. In some embodiments, one or more of the plurality of cartridges includes any one or more of a blade body, an elastic member that pulls a skin surface, a fin including a plurality of protrusions, and a lubrication member including a lubricant that smooths movement of the blade body on the skin surface of a user. One or more of the plurality of includes a connection portion capable of being detachably connected to other cartridges, and the cartridges are directly connected to one another without any interposed parts therebetween.

### CROSS-REFERENCE TO RELATED APPLICATIONS

This application is a continuation of International Application No. PCT/JP2023/005931, filed Feb. 20, 2023, which claims priority to Japanese Application No. 2022-059122, filed Mar. 31, 2022, each of which are incorporated herein in their entireties.

### TECHNICAL FIELD

One aspect of the present disclosure relates to a connection type razor head, a razor including the connection type razor head, etc.

### BACKGROUND ART

T-handle razors in recent years are mostly configured so that exchangeable cartridge-type razor head has a plurality of blades. Patent Document 1 discloses a shaving device 1 including a handle interconnect 20, a cartridge support 30, and a set of cartridges 40. In this shaving device 1, end 80 of the cartridge support 30 is configured to bridge between the cartridges 40 and the handle interconnect 20.

### CITATION LIST

### Patent Document

Patent Document 1: WO No. 2010/010517

### SUMMARY

### Technical Problem

However, in the shaving device disclosed in Patent Documents 1, the number of blades is determined by the cartridge support, and a user cannot freely determine the number of blades. Moreover, since a lubricating strip is disposed on a carrier or a leading platform, a user cannot freely select a lubricant.

### Solution to Problem

In order to solve the above-described problems, the disclosure provides the following means.

A connection type razor head according to one aspect of the present disclosure is formed by connecting a plurality of cartridges to one another.

In accordance with the above-described connection type razor head, a user can freely change the number of blades, the user himself/herself can change the configuration of the blades to a configuration of one blade for a region small in area, and a configuration of many blades, such as three or more or five or more blades, for a region large in area. Consequently, it is possible to provide a razor head to be changed to a razor head having the number of blades according to the user's preference and capable of flexibly responding a user's need.

Moreover, there is no need to provide razor heads with different numbers of blades. This means, for example, that the needs of users can be met without having to individually manufacture one-blade, three-blade, and five-blade razor heads. This eliminates the need for individual production lines and reduces manufacturing costs.

In the above-described connection type razor head, it is preferable that the cartridge includes a blade body and a skin contact member positioned in front of the blade body.

In accordance with the above-described connection type razor head, since it is configured to include the skin contact member, a burden on a user's skin can be reduced.

In the above-described connection type razor head, it is preferable that the cartridge includes any one or more of a blade body, an elastic member that pulls a skin surface, a fin including a plurality of protrusions, and a lubrication member including a lubricant that smooths movement of the blade body on the skin surface of a user.

In accordance with the above-described connection type razor head, it is possible to, in accordance with the user's preference, not only change the number of blades, but also to freely select the elastic member, the fin, and the lubrication member.

In the above-described connection type razor head, it is preferable that the cartridge includes a connecting portion capable of being detachably connected to other cartridges, and the cartridges are directly connected to one another without any interposed parts therebetween.

In accordance with the above-described connection type razor head, since there is no interposed part in interconnection between the cartridges, the number of blades of the razor head, etc. can be further flexibly changed.

In the above-described connection type razor head, it is preferable that the connecting portion is provided at each of both end portions in a width direction of the cartridge.

In accordance with the above-described connection type razor head, the cartridges can be steadily connected to one another.

In the above-described connection type razor head, it is preferable that each of both the end portions protrudes more toward the skin surface side than the blade body.

In accordance with the above-described connection type razor head, since the blade body is prevented from coming into contact with the skin surface with strong pressure, a burden on the user's skin can be reduced.

A razor according to one aspect of the present disclosure includes: the connection type razor head according to any one of the above; and a handle including an underbar configured to detachably hold the connection type razor head.

In accordance with the above-described razor, it can be configured to make it possible to utilize a razor head to be changed to the number of blades according to the user's preference and capable of flexibly responding a user's need.

A razor head according to one aspect of the present disclosure includes: an end surface on which a blade body is provided; and an extension surface that is continuous from the end surface and extends in a direction away from a skin surface, wherein the extension surface is longer than the end surface.

In accordance with the above-described razor head, the razor head is shaped to be able to be directly gripped, and can be configured to also serve as a handle.

In the above-described razor head, it is preferable that the extension surface includes a first extension surface on which a first connection structure is provided, and a second extension surface positioned on an opposite side to the first extension surface, the second extension surface on which a second connection structure is provided, wherein the first connection structure can be connected to the second connection structure.

In accordance with the above-described razor head, it can be configured so that the razor heads can be easily connected to one another in any shape. Accordingly, it is possible to utilize the razor head according to the further user's preference.

A razor according to one aspect of the present disclosure includes: the razor head described in any one of the above; and a clamping member configured to clamp the razor head.

In accordance with the above-described razor, it is possible to provide the razor, etc. in which the razor heads can be easily connected to one another in any shape.

### BRIEF DESCRIPTION OF DRAWINGS

FIG. 1 is a perspective view of a razor including a razor head in an embodiment 1.

FIG. 2 is a perspective view of the razor including the razor head in the embodiment 1.

FIG. 3 is a perspective view of a handle in the razor of the embodiment 1.

FIG. 4 is a perspective view of a cartridge of the razor head in the embodiment 1.

FIG. 5 is a perspective view of the cartridge of the razor head in the embodiment 1.

FIG. 6 is a view for explaining attachment and detachment of the cartridge using a case.

FIG. 7 is a view illustrating the attachment and detachment of the cartridge using the case.

FIG. 8 is a perspective view of a cartridge of a razor head in a modified example 1.

FIG. 9 is a perspective view of the cartridge of the razor head in the modified example 1.

FIG. 10 is a perspective view of a cartridge of a razor head in a modified example 2.

FIG. 11 is a perspective view of the cartridge of the razor head in the modified example 2.

FIG. 12 is a perspective view of a cartridge of a razor head in a modified example 3.

FIG. 13 is a perspective view of the cartridge of the razor head in the modified example 3.

FIG. 14 is a perspective view of a cartridge of a razor head in an embodiment 2.

FIG. 15 is a perspective view of the cartridge of the razor head in the embodiment 2.

FIG. 16 is a perspective view of the razor including the razor head in the embodiment 2.

FIG. 17 is a view illustrating one aspect of connection between the cartridges in the razor head of the embodiment 2.

### DESCRIPTION OF EMBODIMENTS

One aspect of a razor including a connection type razor head according to the present disclosure is characterized in that a razor head is formed by connecting a plurality of cartridges to one another.

Hereinafter, embodiments and modified examples of the razor including the connection type razor head of the present disclosure will be specifically described with reference to the drawings. However, the embodiments described in the following are merely examples of the present disclosure, and do not intend the technical range of the present disclosure to be restrictively interpreted. It is to be noted that, in the drawings, the same components are represented with the same reference signs. A connection type razor head may be referred to herein simply as a “razor head”.

### Embodiment 1

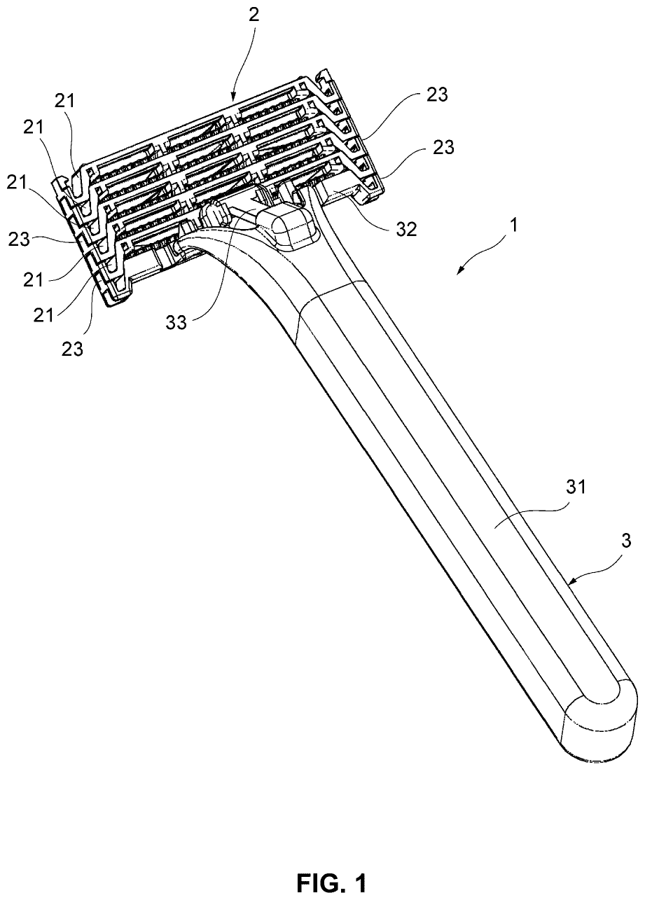

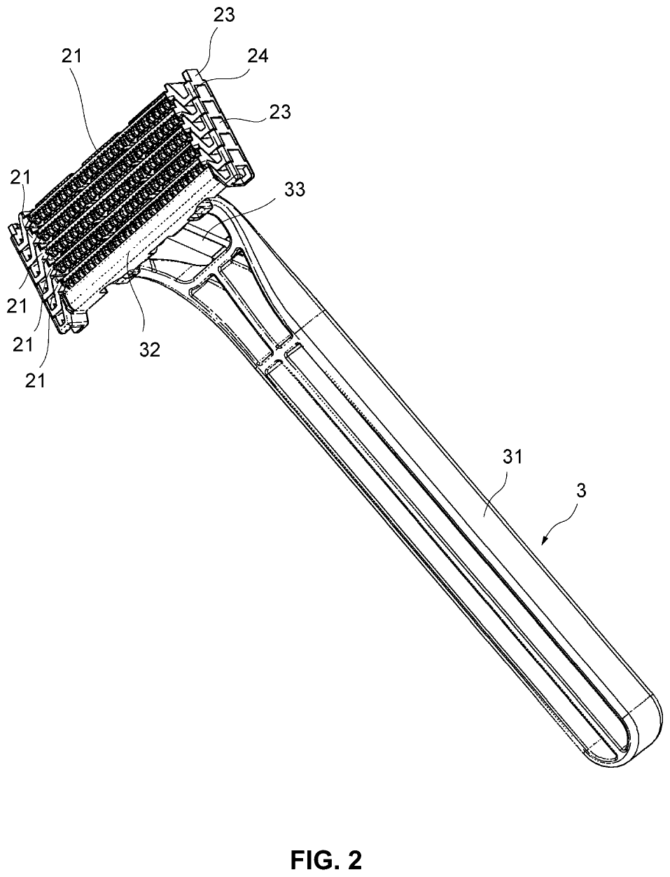

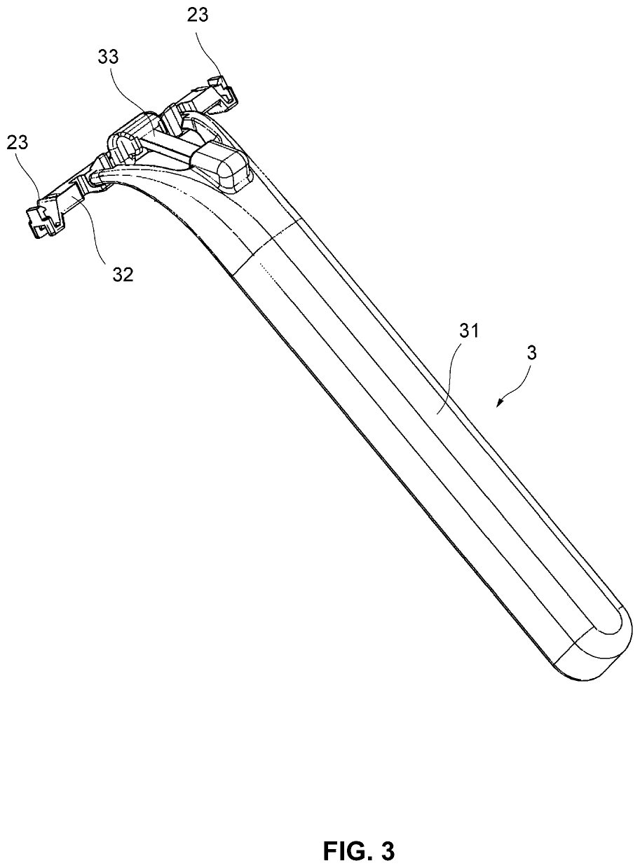

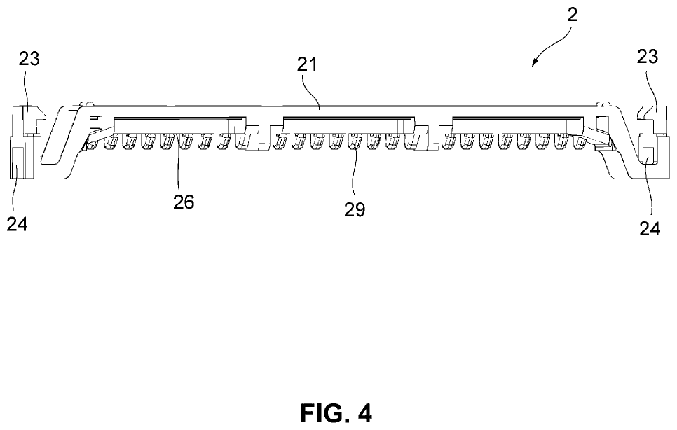

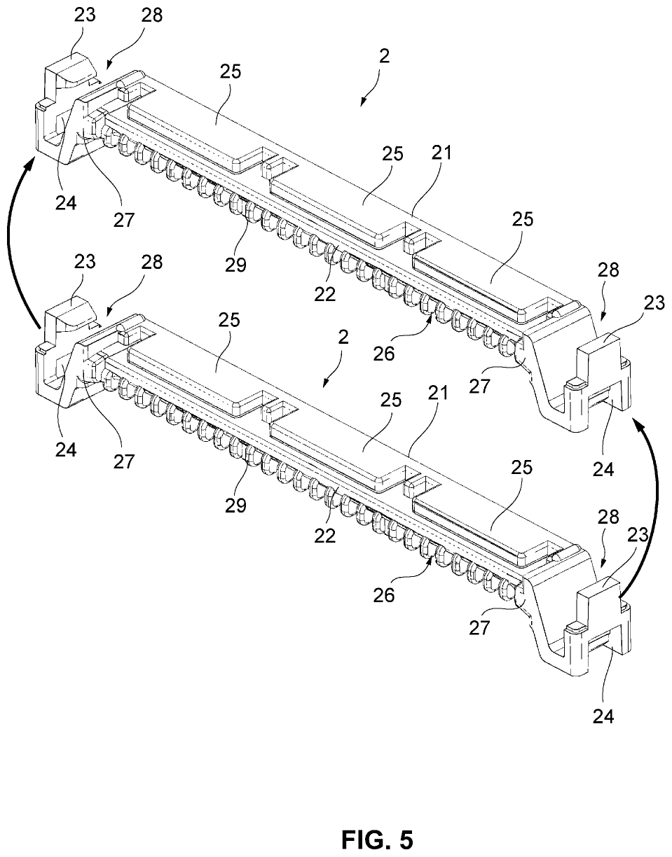

FIGS. 1 and 2 are perspective views of a razor 1 including a razor head 2 of the present embodiment, each viewed from a different angle. FIG. 3 is a perspective view of a handle 3 in the razor 1 of the present embodiment. FIGS. 4 and 5 are perspective views of a cartridge 21 forming the razor head 2 of the present embodiment, each viewed from a different angle.

As illustrated in FIGS. 1 and 2, the razor 1 of the present embodiment includes the razor head 2 and the handle 3. The razor head 2 is formed of five cartridges 21 and is attached to an underbar 32 of the handle 3.

In this specification, a side where the razor head 2 is positioned in a direction in which a gripping portion 31 of the handle 3 extends is referred to as the “upper side” and an opposite side thereto is referred to as the “lower side”. Moreover, a direction perpendicular to the direction in which the gripping portion 31 extends may be referred to as the “width direction” and a length in the width direction may be referred to as the “width”.

As illustrated in FIGS. 4 and 5, the cartridge 21 is formed of a resin or the like so as to extend in a width direction perpendicular to a direction in which the gripping portion 31 of the handle 3 extends, and holds a blade body 22. A hook 23 and an engagement groove 24 which function as a connecting portion are provided at each of both ends in the width direction of the cartridge 21. The hooks 23 of a cartridge 21 to be connected or the underbar 32 described below are respectively and detachably fitted into the engagement grooves 24 of the cartridge 21, and thereby the cartridges 21 are connected to each other or the cartridge 21 and the underbar 32 are connected to each other. Namely, the cartridges 21 are detachably connected to each other. In order to fit this hook 23 into the engagement groove 24, as illustrated in FIG. 5, the hook 23 is pushed toward the engagement groove 24, causing the hook 23 to elastically deform and bend outside, and then the hook 23 is further pushed in so that hook 23 returns to a position before the elastic deformation beyond an edge of the engagement groove 24.

The cartridge 21 has an upper blade body clamping portion 25 and a lower blade body clamping portion 26 configured to clamp the blade body 22. The upper blade body clamping portion 25 is positioned on an upper side of the blade body 22, and the lower blade body clamping portion 26 is positioned on a lower side of the blade body 22. The blade body 22 is clamped between the upper blade body clamping portion 25 and the lower blade body clamping portion 26, and is fixed to the cartridge 21 by bonding, engagement, or the like. The blade body 22 is formed of a metal such as stainless steel. The upper blade body clamping portion 25 may be divided into a plurality of portions, such as divided into three portions in the width direction, as illustrated in FIG. 5.

On further lower side of the lower blade body clamping portion 26, a skin contact member 29 is provided. In other words, the skin contact member 29 is positioned before the blade body 22 in a moving direction of the razor head 2 during use, and therefore is positioned in front of the blade body 22. As illustrated in FIG. 5 etc., a plurality of the skin contact member 29 are comb-shaped provided at predetermined intervals in the width direction. The skin contact member 29 protrudes further than the blade body 22 on a side in which the blade body 22 protrudes. The skin contact member 29 is in contact with a user's skin surface before the blade body 22 during use. Since such a skin contact member 29 is provided, during use, the skin contact member 29 leads the blade body 22, and a tangled body hair before shaving is pre-combed by the comb-shape of the skin contact member 29, so that the body hair comes into contact with the blade body 22 in an aligned state. Accordingly, it can be configured to easily shave the body hair reliably by the blade body 22.

At each of both ends of the cartridge 21, which is positions closer to the center than the hook 23 and the engagement groove 24, a skin contact end portion 27 protruding further than the blade body 22 are provided, on a side where the blade body 22 protrudes. The skin contact end portion 27 is in contact with the user's skin surface when the user uses the razor 1 including the cartridge 21. The razor 1 is configured so that the cartridge 21 is provided at both ends with the hooks 23 and the engagement grooves 24 so as to double as the skin contact end portions 27. Both ends of the cartridge 21 are designed to be cohesively shaped into a substantially smooth surface. Accordingly, corners and unevenness of structural members are generally exposed from coupling portions between structural members, but such corners and unevenness of the cartridge 21 in the present embodiment are minimized.

As illustrated in FIGS. 1 to 3, the handle 3 includes the gripping portion 31, the underbar 32, and a restricting portion 33. The handle 3 is formed of a resin or the like. The gripping portion 31 extends in a direction perpendicular the direction in which the cartridge 21 extends and is gripped by a user during use. The underbar 32 is disposed on an upper end of the gripping portion 31 and is rotatably supported by the gripping portion 31. The rotation of the underbar 32 is restricted by the restricting portion 33. A hook 23 having the same shape as the hook 23 of the cartridge 21 is provided at each of both ends of the underbar 32. As described above, this hook 23 is detachably fitted into and thereby connected to the engagement groove 24 of the cartridge 21.

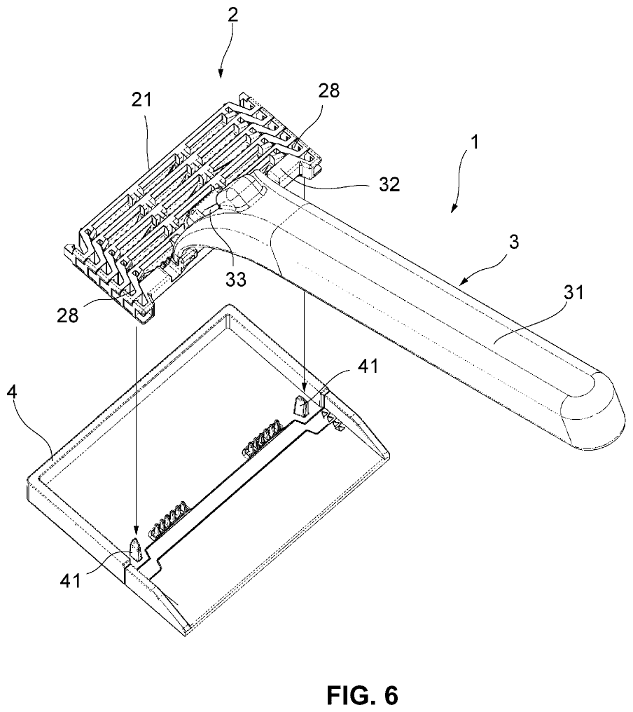

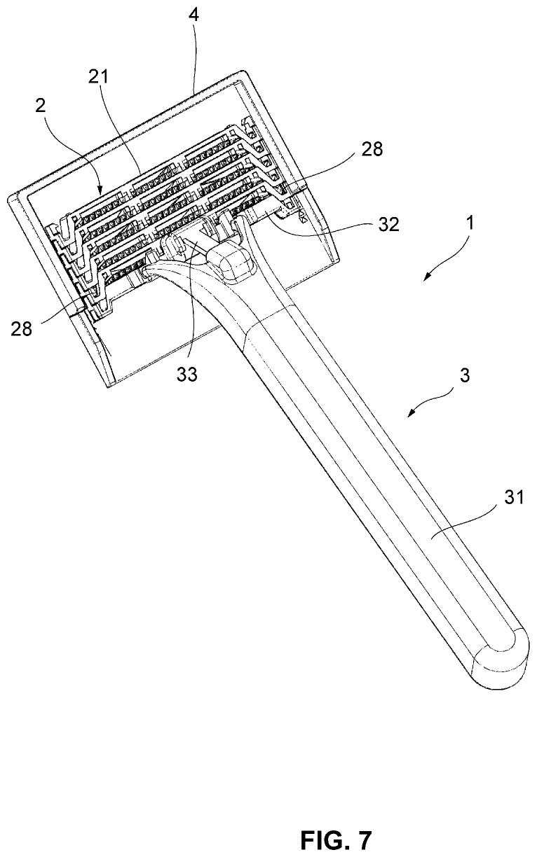

FIGS. 6 and 7 are views for explaining attachment/detachment of the cartridge 21 to/from the handle 3 using the case 4. Attachment/detachment of the cartridge 21 to/from the handle 3 can be realized by using the case 4 as describe below, but is not limited to this example.

As illustrated in FIG. 5, a recessed portion 28 is provided between the skin contact end portion 27 and the hook 23 and engagement groove 24 at each of both ends of the cartridge 21. On the other hand, as illustrated in FIG. 6, two pins 41 fitted into the cartridge 21 by being inserted into the recessed portions 28 are provided on the case 4. The case 4 is formed of a resin or the like.

In order that the cartridge 21 attached to the handle 3 is detached therefrom, the recessed portions 28 of the cartridge 21 are fitted into the pins 41 of the case 4. At this time, the pin 41 is in contact with inside the hook 23, and consequently the hook 23 elastically deforms outside, thereby releasing the fitting of the hook 23 into the engagement groove 24. From this state, by pulling the handle 3 toward the lower end of the handle 3 as illustrated in FIG. 7, the cartridge 21 including the recessed portion 28 into which the pin 41 is inserted, and cartridges 21 provided above this cartridge 21, are detached from the handle 3.

Moreover, the case 4 can be used also in order to attach the cartridge 21 to the handle 3. In this case, in a state where the cartridge 21 to be attached is being fitted to the pin 41 of the case 4, the underbar 32 of the handle 3, or the cartridge 21 attached to the handle 3 is pushed into the cartridge 21 currently fitted to the case 4 from the underside. Consequently, the underbar 32 or the hook 23 of the cartridge 21 is fitted into the engagement groove 24 of the cartridge 21 currently fitted to the case 4. From this state, the handle 3 to which the cartridge 21 is attached is pulled out from the case 4 in a direction in which the pin 41 extends, and thereby the cartridge 21 is attached to the handle 3.

Alternatively, the cartridge 21 may be provided with any one of an elastic member, fins, and a lubrication member, instead of the blade body 22. The elastic member is an elastic member such as a resin or rubber, which acts to pull the skin surface by friction during use. This elastic member allows the user's mustache and other body hair to rise, during use, making it easier to shave the body hair with the razor 1. The fin is formed of a plurality of protrusions formed of a resin or rubber protruded from a surface of the cartridge 21. The fin acts to rise the body hair on the user's skin surface with which the fin come into contact, and bring a knife point of the succeeding blade body 22 into contact with a root of the body hair. Consequently, a deep shave effect can be obtained. The lubrication member includes a lubricant that enables the blade body 22 of the razor 1 to move smoothly on the user's skin surface. This lubricant may be a mixture of different lubricants for users, such as for users with sensitive skin, for users who want a feeling of freshness, and the like.

Since the razor 1 in the present embodiment can have as many cartridges 21 connected as desired, the number of blade bodies 22 can be changed as desired. Moreover, since the cartridge 21 provided with the elastic member, the fin, or the lubrication member instead of the blade body 22 can be connected as described above, the razor head 2 to be configured according to the user preference can be used.

### Modified Examples

Next, a modified example of the embodiment 1 will be described. In the following modified example, cartridges having a different configuration from the cartridge 21 will be described, but they are similar at a point of including a connecting portion that enables cartridges to be connected to one another.

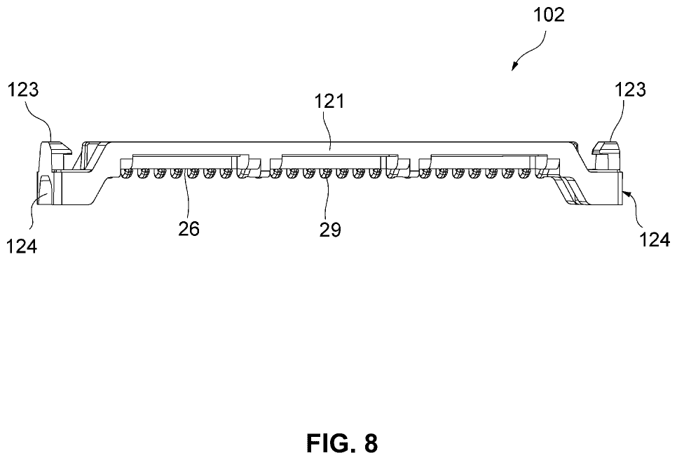

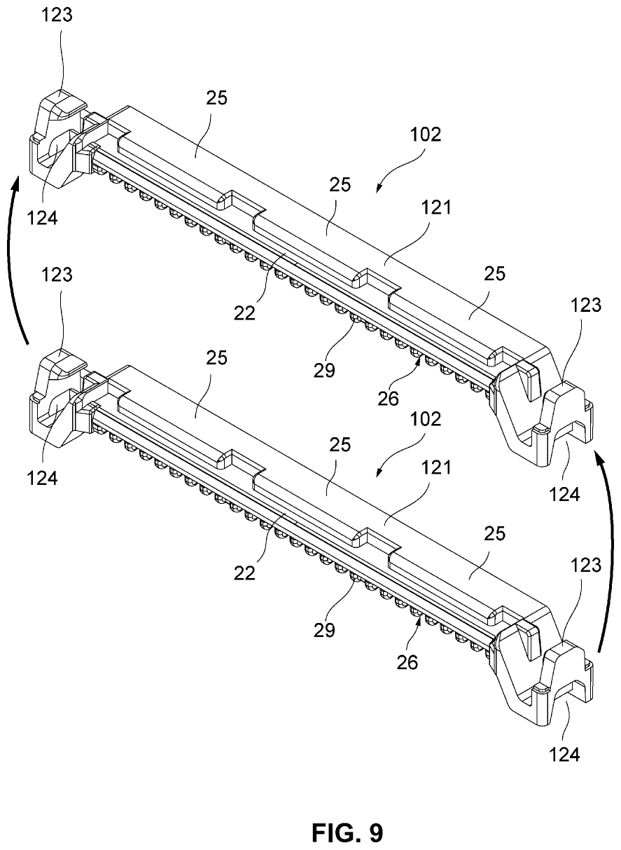

FIGS. 8 and 9 are perspective views of a cartridge 121 forming a razor head 102 in the modified example 1. As illustrated in FIGS. 8 and 9, the cartridge 121 is formed of a resin or the like so as to extend in a width direction perpendicular to a direction in which the gripping portion 31 of the handle 3 extends, and holds a blade body 22. A hook 123 and an engagement groove 124 which function as a connecting portion are provided at each of both ends of the cartridge 121. The hooks 123 of a cartridge 121 to be connected or the underbar 32 are detachably fitted into the engagement grooves 124 of the cartridge 121, and thereby the cartridges 121 are connected to each other or the cartridge 121 and the underbar 32 are connected to each other. Namely, the cartridges 121 are detachably connected to each other. In order to fit this hook 123 into the engagement groove 124, as illustrated in FIG. 9, the hook 123 is pushed toward the engagement groove 124, causing the hook 123 to elastically deform and deflect outward, and then the hook 123 is further pushed in so that hook 123 returns to a position before the elastic deformation beyond an edge of the engagement groove 124. It is to be noted that the underbar 32 to which the cartridge 121 in the modified example 1 is detached/attached includes a hook 123 of the same shape as the hook 123 of the cartridge 121.

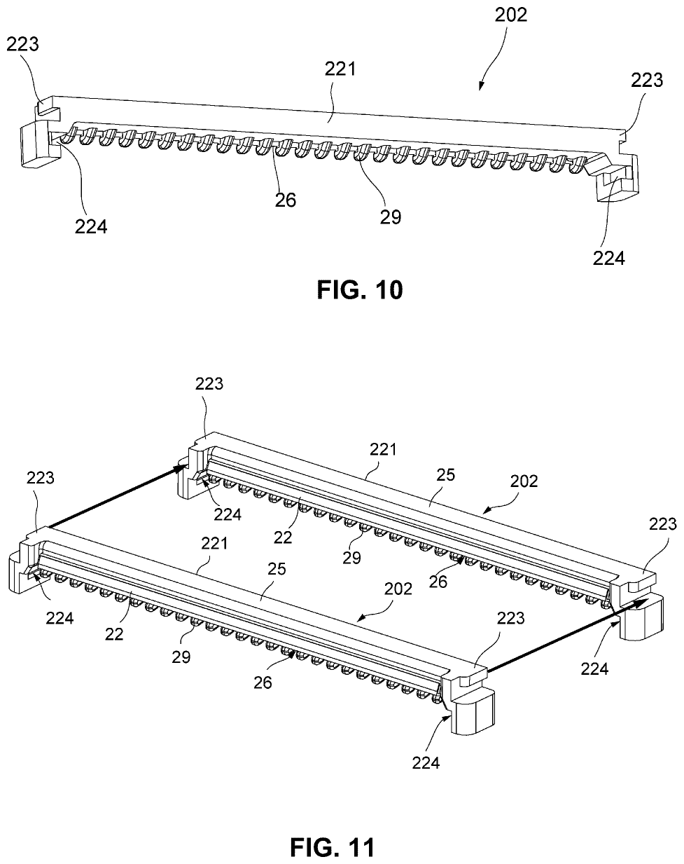

FIGS. 10 and 11 are perspective views of a cartridge 221 forming a razor head 202 in the modified example 2. As illustrated in FIGS. 10 and 11, the cartridge 221 is formed of a resin or the like so as to extend in a width direction perpendicular to a direction in which the gripping portion 31 of the handle 3 extends, and holds a blade body 22. An engagement protrusion 223 and an engagement groove 224 which function as a connecting portion are provided at each of both ends of the cartridge 221. The engagement protrusions 223 of a cartridge 221 to be connected or the underbar 32 are detachably fitted into the engagement grooves 224 of the cartridge 221, and thereby the cartridges 221 are connected to each other or the cartridge 221 and the underbar 32 are connected to each other. Namely, the cartridges 221 are detachably connected to each other. In order to fit this engagement protrusion 223 into the engagement groove 224, as illustrated in FIG. 11, the engagement protrusion 223 is pressed in so as to slide toward the engagement groove 224, and thereby the engagement protrusion 223 and the engagement groove 224 are fitted to each other. It is to be noted that the underbar 32 to which the cartridge 221 in the modified example 2 is detached/attached includes an engagement protrusion 223 of the same shape as the engagement protrusion 223 of the cartridge 221.

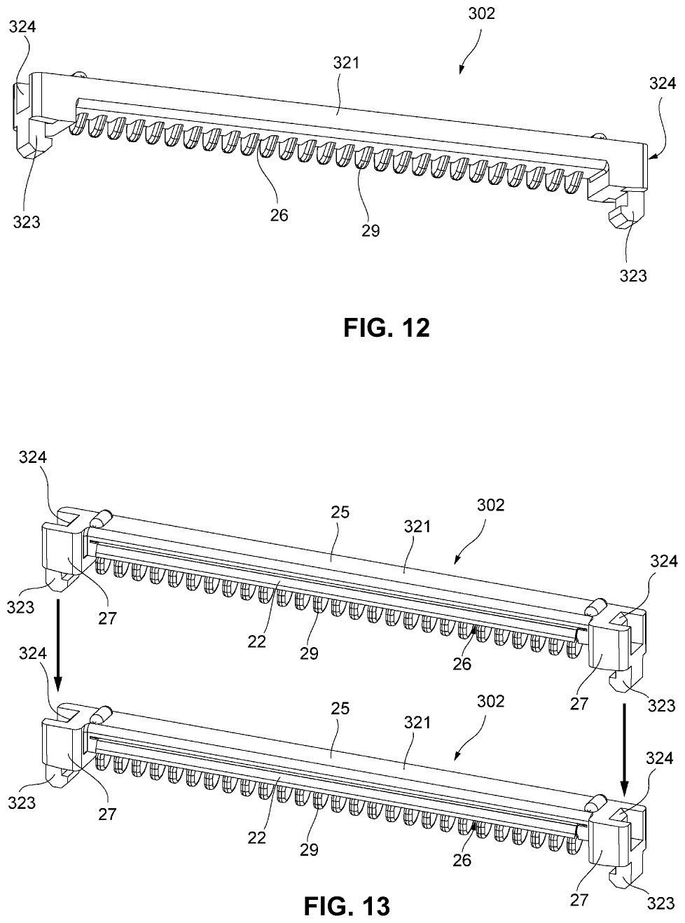

FIGS. 12 and 13 are perspective views of a cartridge 321 forming a razor head 302 in the modified example 3. As illustrated in FIGS. 12 and 13, the cartridge 321 is formed of a resin or the like so as to extend in a width direction perpendicular to a direction in which the gripping portion 31 of the handle 3 extends, and holds a blade body 22. A hook 323 and an engagement groove 324 which function as a connecting portion are provided at each of both ends of the cartridge 321. A cartridge 321 to be connected is detachably fitted into the engagement grooves 324 of the cartridge 321, and thereby the cartridges 321 are connected to each other. Namely, the cartridges 321 are detachably connected to each other. The underbar 32 to which the cartridge 321 in the modified example 3 is detached/attached includes an engagement groove 324 of the same shape as those of the cartridge 321. The hook 323 of the cartridge 321 and the engagement groove 324 of the underbar 32 are fitted to each other, and thereby the cartridge 321 and the underbar 32 are connected to each other. In order to fit this hook 323 into the engagement groove 324, as illustrated in FIG. 13, the hook 323 is pushed toward the engagement groove 324, causing the hook 323 to elastically deform and deflect outward, and then the hook 323 is further pushed in so that hook 323 returns to a position before the elastic deformation beyond an edge of the engagement groove 324.

### Embodiment 2

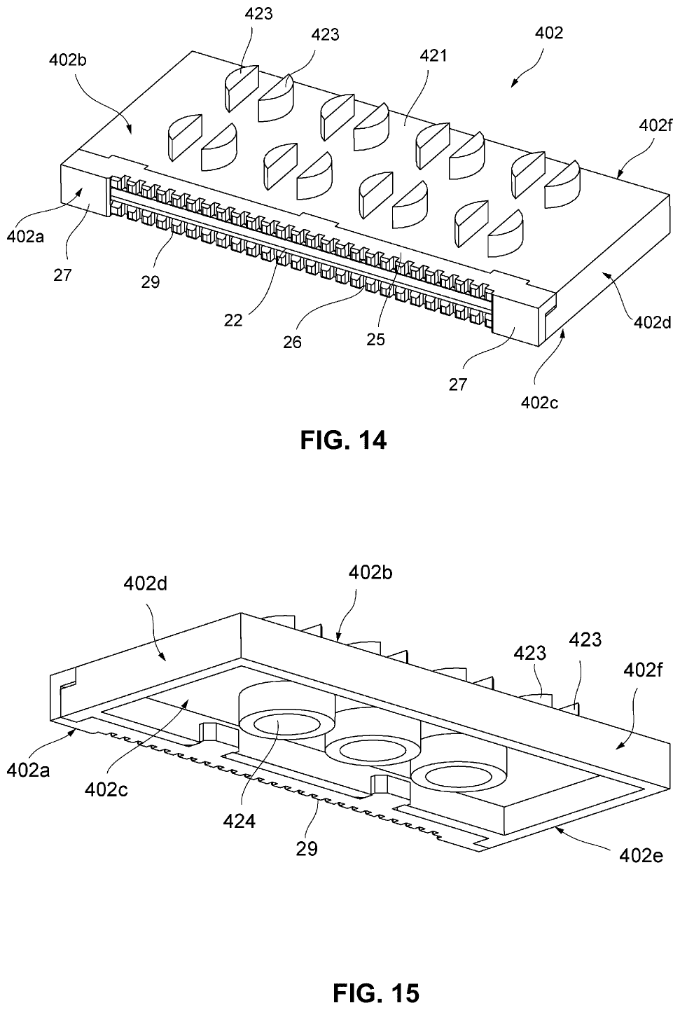

FIGS. 14 and 15 are perspective views of a cartridge 421 forming a razor head 402 in the embodiment 2. The cartridge 421 of the present embodiment differs from the embodiment 1 and the modified examples thereof in a configuration of the connecting portion, and the configuration of the handle to be attached. Moreover, the cartridge 421 of the present embodiment can be connected in a different aspect from that of the embodiment 1.

As illustrated in FIGS. 14 and 15, the cartridge 421 has a rectangular parallelepiped shape and includes six surfaces 402a, 402b, 402c, 402d, 402e, and 402f. The cartridge 421 is formed of a resin or the like.

The blade body 22 is provided on an end surface 402a of the cartridge 421 so as to be exposed therefrom. The blade body 22 is clamped between the upper blade body clamping portion 25 and the lower blade body clamping portion 26. A skin contact end portion 27 protruding further than the blade body 22, on a side where the blade body 22 protrudes, is provided on each of the both of end portions of the end surface 402a of the cartridge 421.

The cartridge 421 includes the upper extension surface 402b and the lower extension surface 402c, each continuous from the end surface 402a. The upper extension surface 402b and the lower extension surface 402c extend in a direction away from the end surface 402a that is in contact with the user's skin surface during use. The upper extension surface 402b and the lower extension surface 402c have the same width as the end surface 402a, but are formed to be longer than the end surface 402a. As illustrated in FIG. 14, protrusions 423 that protrude toward an upper side are formed on the upper extension surface 402b. The protrusion 423 has a cylindrical shape with the center portion removed, leaving only the left and right portions. Namely, each of the protrusions 423 has a pillar shape in which the cross section that is shaped like a part of a circle. This protrusion 423 may be cylindrical. Recessed portions 424 respectively fitted to the protrusions 423 are formed on the lower extension surface 402c. As shown in FIG. 15, the recessed portion 424 has a pillar shape with a circular cross section. One recessed portion 424 can be fitted to the four protrusions 423 by contacting an outer edge of the recessed portion with the outer edges of the four protrusions. The cartridges 421 can be connected to each other such that the upper extension surface 402b and the lower extension surface 402c completely overlap each other, or such that the upper extension surface 402b and the lower extension surface 402c are displaced from each other. The protrusion 423 of the cartridge 421 is an example of the “first connection structure” of the present disclosure, and the recessed portion 424 is an example of the “second connection structure” of the present disclosure. The connecting mechanism is not limited to such an aspect, but other aspects of connecting mechanisms may be adopted.

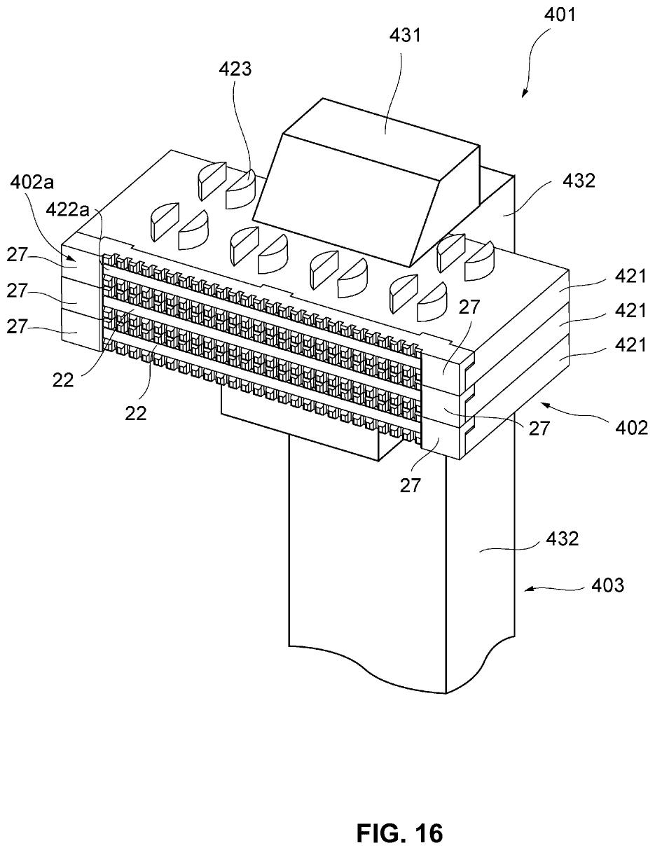

FIG. 16 is a perspective view of a razor 401 in which a razor head 402 including three cartridges 421 is connected to a handle 403. In the razor head 402, the three cartridges 421 are connected to one another such that the respective upper extension surfaces 402b and the respective lower extension surfaces 402c completely overlap. Among the three cartridges 421, only the uppermost cartridge 421 has a lubrication member 422a instead of the blade body 22.

The handle 403 includes a gripping portion 432 and a head clamping portion 431. The gripping portion 432 is a portion gripped by a user during use and is connected to a lower side of the razor head 402. Protrusions 423 similar to those on the upper extension surface 402b of the cartridge 421 are formed on a surface of the gripping portion 432 which is in contact with the lower side of the razor head 402. A head clamping portion 431 is attached to an upper side of the razor head 402. Recessed portions 424 similar to those on the lower extension surface 402c of the cartridge 421 are formed on a surface of the head clamping portion 431 which is in contact with the upper side of the razor head 402. Protrusions 423 similar to those on the upper extension surface 402b are formed on an upper side surface of the gripping portion 432 which is in contact with the head clamping portion 431, and recessed portions 424 similar to those on the lower extension surface 402c are formed on a lower side surface of the head clamping portion 431 which is in contact with the aforementioned upper side surface of the gripping portion. In accordance with such a configuration, the razor head 402 is clamped by the gripping portion 432 of the handle 403 and the head clamping portion 431. That is, the gripping portion 432 and the head clamping portion 431 are clamping members for clamping the razor head 402.

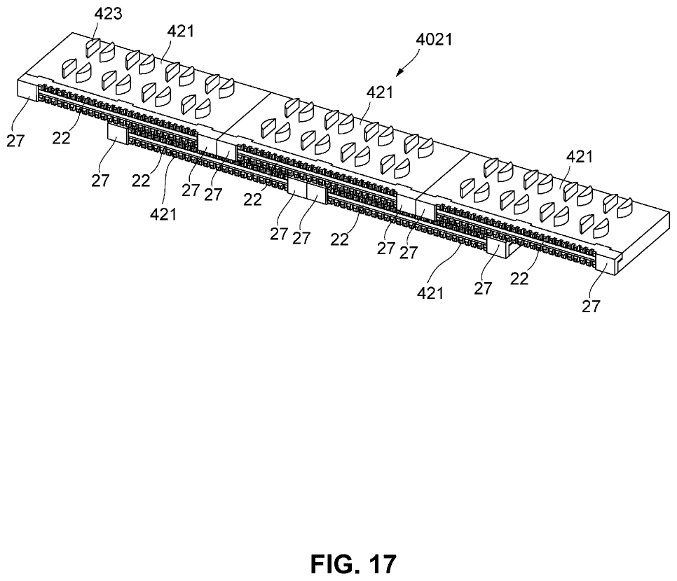

FIG. 17 is a view illustrating a razor head 4021 including five cartridges 421, which illustrates one aspect of connection between the cartridges 421. As illustrated in FIG. 17, the cartridges 421 can be connected to one another so as to be aligned in the width direction, thereby increasing the width of the blade body 22 of the razor head 4021. Moreover, it is also possible to connect the cartridges 421 in a staggered manner in multiple stages, as shown in FIG. 17. In such a razor head 4021, even parts of the body hair that cannot be shaved during use when the cartridges 421 are arranged in a row since the cartridge 421 is provided with the skin contact end portions 27 on both ends can be shaved by using the cartridges 421 arranged in a different stage. Thus, the cartridges 421 of the present embodiment can be connected to one another in various aspects.

### Other Modified Examples

The razor head and the razor according to the present disclosure are not limited to the above-described aspects of the embodiments and the modified examples, and further modifications may be adopted thereinto.

The aspects of connecting the cartridges are not limited to the exemplifications, but other aspects of connecting mechanisms may be adopted thereinto.

In the embodiments, a configuration in which the cartridge has one blade body, elastic member, fin, or lubrication member has been exemplified, but a configuration in which a single cartridge includes two or more of the same or different blade bodies, elastic members, fins, and lubrication members may also be used.

### [Features of Razor Head and Razor]

The connection type razor head 2 in the embodiment 1 is formed by connecting a plurality of cartridges 21 to one another. The same applies to each of the modified examples and the embodiment 2.

In accordance with an investigation by the inventors, it is found that razors with small heads with a single blade are preferred for shaving regions small in area, while razors with three or more blades are preferred for shaving regions large in area. In accordance with the above-described connection type razor head 2, a user can freely change the number of blades, the user himself/herself can change the configuration of the blades to a configuration of one blade for a region small in area, and a configuration of many blades, such as three or more or five or more blades, for a region large in area. Consequently, it is possible to provide a razor head 2 to be changed to a razor head 2 having the number of blades according to the user's preference and capable of flexibly responding a user's need.

Moreover, by using such a razor head 2, it becomes unnecessary to provide razor heads 2 each having a different number of blades. This means, for example, that the needs of users can be met without having to individually manufacture one-blade, three-blade, and five-blade razor heads 2. This eliminates the need for individual production lines and reduces manufacturing costs.

In the razor head 2 of the embodiment 1, the cartridge 21 includes a blade body 22 and a skin contact member 29 positioned in front of the blade body 22. The same applies to each of the modified examples and the embodiment 2. In accordance with this configuration, the razor head 2 can reduce a burden on the user's skin.

The razor head 2 of the embodiment 1 is configured so that the cartridge 21 includes any one or more of a blade body 22, an elastic member that pulls a skin surface, a fin including a plurality of protrusions, and a lubrication member including a lubricant that smooths movement of the blade body on the skin surface of a user. The same applies to each of the modified examples and the embodiment 2. Consequently, in the razor head 2, it is possible to, in accordance with the user's preference, not only change the number of blades, but also to freely select the elastic member, the fin, and the lubrication member.

In the razor head 2 of the embodiment 1, the cartridge 21 includes hooks 23 and engagement grooves 24 which function as a connecting portion capable of being detachably connected to other cartridges 21. In this case, the cartridges 21 are directly connected to one another without any interposed parts therebetween. The configurations of each modified example and the embodiment 2 also have the similar mechanism, although the specific configuration that functions as the connecting portion is different. Therefore, in accordance with the razor head 2, there is no interposed part in the interconnection between the 21 cartridges, allowing for more flexibility in changing the number of blades in the razor head 2.

In the razor head 2 of the embodiment 1, the hook 23 and the engagement groove 24 which function as the connecting portion are provided at each of end portions in the width direction of the cartridge 21. Each of the modified examples also has the similar configuration. Accordingly, in the razor head 2, the cartridge 21 can be steadily connected to one another.

In the razor head 2 of the embodiment 1, the skin contact end portion 27 provided at each of the end portions protrudes more toward the skin surface side than the blade body 22. Each of the modified examples and the embodiment 2 also have the similar configuration. Accordingly, in the razor head 2, since the blade body 22 is prevented from coming into contact with the user's skin surface with strong pressure, a burden on the user's skin can be reduced.

The razor 1 in the embodiment 1 includes a razor head 2 and a handle 3. The handle 3 includes an underbar 32 configured to detachably hold this razor head 2. Each of the modified examples also has the similar configuration. Accordingly, the razor 1 is configured to make it possible to utilize a razor head 2 to be changed to a razor head 2 having the number of blades according to the user's preference and capable of flexibly responding a user's need.

The cartridge 421 of the razor head 402 in the embodiment 2 includes an end surface 402a on which a blade body 22 is provided; and an upper extension surface 402b and a lower extension surface 402c, each continuous from the end surface 402a and extending in a direction away from the skin surface. Moreover, both have the same width, but the upper extension surface 402b and the lower extension surface 402c are formed to longer than the end surface 402a. Accordingly, the razor head 402, with any combination of cartridges 421, can be directly grasped and used by the user, and the razor head 402 can be configured to also serve as a handle.

In the cartridge 421 of the razor head 402 in the embodiment 2, protrusions 423 are formed on the upper extension surface 402b, and recessed portions 424 are formed on the lower extension surface 402c. The protrusion 423 and the recessed portion 424 can be connected to each other. This allows the cartridges 421 to be easily connected to one another in any shape. Accordingly, it is possible to utilize the razor head 402 according to the further user's preference.

The razor 401 of the embodiment 2 includes a razor head 402, and a gripping portion 432 and a head clamping portion 431 which clamp the razor head 402. Namely, the razor head 402 is clamped between the gripping portion 432 and the head clamping portion 431. In accordance with such a razor 401, it is possible to utilize the razor head 402 in which the cartridges 421 are connected to one another in any shape.

### REFERENCE SIGNS LIST

1, 401 Razor
2, 102, 202, 302, 402, 4021 Razor head
21, 121, 221, 321, 421 Cartridge
22 Blade body
422a Lubrication member
23, 123, 323 Hook
223 Engagement protrusion
423 Protrusion
24, 124, 224, 324 Engagement groove
424 Recessed portion
Upper blade body clamping portion
26 Lower blade body clamping portion
27 Both-end skin contact portion
28 Recessed portion
29 Skin contact member
402a End surface
402b Upper extension surface
402c Lower extension surface
3, 403 Handle
31 Gripping portion
32 Underbar
33 Restricting portion
431 Head clamping portion
432 Gripping portion
4 Case
41 Pin

1-10. (canceled)

11. A connection type razor head formed by connecting a plurality of cartridges to one another.

12. The connection type razor head according to claim 11, wherein the cartridge comprises a blade body and a skin contact member positioned in front of the blade body.

13. The connection type razor head according to claim 11, wherein the cartridge comprises any one or more of a blade body, an elastic member that pulls a skin surface, a fin including a plurality of protrusions, and a lubrication member including a lubricant that smooths movement of the blade body on the skin surface of a user.

14. The connection type razor head according to claim 12, wherein the cartridge comprises a connecting portion configured to be detachably connected to other cartridges, and the cartridges are directly connected to one another without any interposed parts therebetween.

15. The connection type razor head according to claim 14, wherein the connecting portion is provided at each of both end portions in a width direction of the cartridge.

16. The connection type razor head according to claim 15, wherein both of the end portions protrude more toward the skin surface side than the blade body.

17. A razor comprising:
the connection type razor head of claim 11; and
a handle including an underbar configured to detachably hold the connection type razor head.

18. A razor head comprising:
an end surface on which a blade body is provided; and
an extension surface that is continuous from the end surface and extends in a direction away from a skin surface,
wherein the extension surface is longer than the end surface.

19. The razor head according to claim 18, wherein:
at the end surface, instead of the blade body, there is provided any one or more of the blade body, an elastic member that pulls a skin surface, a fin including a plurality of protrusions, and a lubrication member including a lubricant that smooths movement of the blade body on the skin surface of a user,
wherein the extension surface comprises:
a first extension surface on which a first connection structure is provided, and
a second extension surface positioned on an opposite side to the first extension surface, the second extension surface on which a second connection structure is provided,
wherein the first connection structure is configured to be connected to the second connection structure.

20. A razor comprising:
the razor head according to claim 18; and
a clamping member configured to clamp the razor head.
